(19) United States
(12) Patent Application Publication
(10) Pub. No.: US 2005/0098016 A1
(43) Pub. Date: May 12, 2005

(54) Air cushion table and conveyor unit

(76) Inventor: Piergiorgio Benuzzi, Bologna (IT)

Correspondence Address: Richard J Minnich;Fay Sharpe Fagan Minnich & Mc Kee, 7th Floor, 1100 Superior Avenue, Cleveland, OH, 44114, US

(21) Appl. No.: 10/363,966

(22) PCT Filed: Jul. 11, 2002
(86) PCT No.: PCT/IB02/02805

(30) Foreign Application Priority Data
Jul. 18, 2001 (IT) BO2001A000458

(51) Int. Cl. B65G 51/03; B27B 3/00

(52) U.S. Cl. 83/733

(57) ABSTRACT

An air cushion support and sliding device (4) of a conveyor unit (24) is equipped with at least one support and sliding table (5) for objects or products, which is made at least partially of a material which is naturally porous to air and, in particular, is a panel (7) with a plurality of natural pores (8) through which the air flows and is distributed in a substantially uniform and capillary fashion on at least one support and sliding surface (9) on the table (5).

### TECHNICAL FIELD

The present invention relates to an air cushion support and sliding device.

The support and sliding device made in accordance with the present invention may be used advantageously for conveying objects or products in various industrial sectors, for example for conveying panels or packs of panels to be cut in a panel saw machine, or in a system using panel saw machines or for handling loads which may be heavy, to which the following description specifically refers, without limiting the scope of application of the invention.

### BACKGROUND ART

Panel saw machines (this being the sector to which reference is made in this text) are normally used for cutting panels or similar items into smaller sub-panels. The panels may be made mainly of wood-based material, but also of other materials such as plastic, light alloys, steel, etc.

Panel saw machines of the known type usually comprise at least one horizontal support and sliding table on which a mobile piece of equipment, commonly known-as a pusher, pushes at least one panel to be cut (preferably stacks of panels in superposed layers) towards a cutting device (or panel rotation device) located downstream.

During the cutting operation, the panel is held in position on the sliding table by gripper elements, such as clamps, operatively attached to the rear edge of the panel. Moreover, along the sliding table, the panel may engage with other, additional positioning, aligning, ejecting, pressing and rotating elements, which are accessories commonly used in panel saw machines.

Panel cutting is possible only along one cutting axis, or, on more complex machines, along two or more cutting axes set at right angles to one another. In the latter case, the panel saw machines are angled and the relative panel support and sliding tables are at 90 degrees to one another. Machines of this type are preferably part of more complex panel treatment systems which can produce stacks of panels then carry them to magazines according to the size of the panels.

Panels are normally cut in groups rather than individually. They are stacked vertically one on top of another, forming packs which are usually large and, as a result, relatively heavy. The weight of the packs of panels therefore necessitates the use of support tables designed to limit the friction on the packs as they slide.

One of the known solutions for facilitating panel pack sliding on support tables consists of making the tables in such a way that they form an air cushion. In this way, the air which flows out of the support and sliding tables pushes the packs of panels upwards, against gravity, and the resulting normal force acting upon the tables is reduced, consequently reducing friction. In particular, air cushion support and sliding devices of known types comprise at least one support and sliding table consisting of a plate with holes in it, normally metal, which forms the upper wall of a ventilated air pipe or distributor box. The through-holes in the plate are usually fitted with stop valves to prevent shavings and machining residues entering the pipe when the air blowing is switched off.

Air cushion support and sliding devices of the above-mentioned known type have several disadvantages. A first disadvantage is the fact that they generate an air cushion which is uneven and not very capillary even with the highest number of holes which can be made in the plate without compromising the capacity for supporting heavy packs of panels. In particular, the maximum number of holes is limited by the need to prevent the plate from bending or, more generally, becoming deformed, under the weight of the panels. Plate deformation would lead to two serious disadvantages, one being deterioration in the table sliding characteristics and the other the possibility of air leaks in the zones in which the plate covers the top of the distributor box. The unevenness and limited spread of the air cushion mean that the air compression must be high in order for each hole to generate a thrust sufficient for correct support and sliding device operation. As well as requiring expensive compressors, this creates a high level of noise, being related to the high speed at which the air exits the above-mentioned holes.

Moreover, the whole device is quite complex to assemble and relatively expensive to produce and maintain. The complexity of assembly also prevents the device from being produced with complex shapes and geometries, normally needed due to ergonomic requirements.

A further disadvantage is the fact that each jet of air exits the respective hole with a pressure, displacement and speed that is high enough to easily carry dust or other polluting agents towards the machining zone. Moreover, both dust and other polluting agents can pass through the holes freely, as the holes are relatively large.

As an alternative to the above-mentioned air cushion support and sliding devices there are known devices in which the support and sliding tables consist of a plurality of idle rollers, side-by-side in a cascade formation. These tables also have some disadvantages, specifically a high noise level, due to the rotation of the rollers, a relatively high production and maintenance cost and limited adaptability to complex ergonomic shapes.

### DISCLOSURE OF THE INVENTION

The aim of the present invention is to provide an air cushion support and sliding device which overcomes the above-mentioned disadvantages.

Accordingly, the present invention provides an air cushion support and sliding device comprising at least one support and sliding table for objects or products. The device is characterised in that the table is made at least partially of a material which is naturally porous to air.

In particular, the table consists of a panel with a plurality of natural pores through which the air flows and is distributed in a substantially even and capillary fashion on at least a first support and sliding surface on the table.

The present invention also relates to a conveyor unit for conveying objects or products.

Accordingly, the present invention provides a conveyor unit for conveying objects or products as described in claim 12 or 13 and/or in any of the claims which, directly or indirectly, are dependent on claim 13.

### BRIEF DESCRIPTION OF THE DRAWINGS

The invention will now be described with reference to the accompanying drawings which illustrate a preferred embodiment of it and in which:

FIG. 1 is a schematic view of a panel saw machine equipped with an air cushion support and sliding device made in accordance with the present invention;

FIG. 2 is a perspective view of a first embodiment of the air cushion support and sliding device made in accordance with the present invention;

FIG. 3 is a perspective view of a second embodiment of the air cushion support and sliding device made in accordance with the present invention; and

FIG. 4 is a perspective view of a conveyor unit for objects or products comprising the air cushion support and sliding device made in accordance with the present invention.

### DETAILED DESCRIPTION OF THE PREFERRED EMBODIMENTS OF THE INVENTION

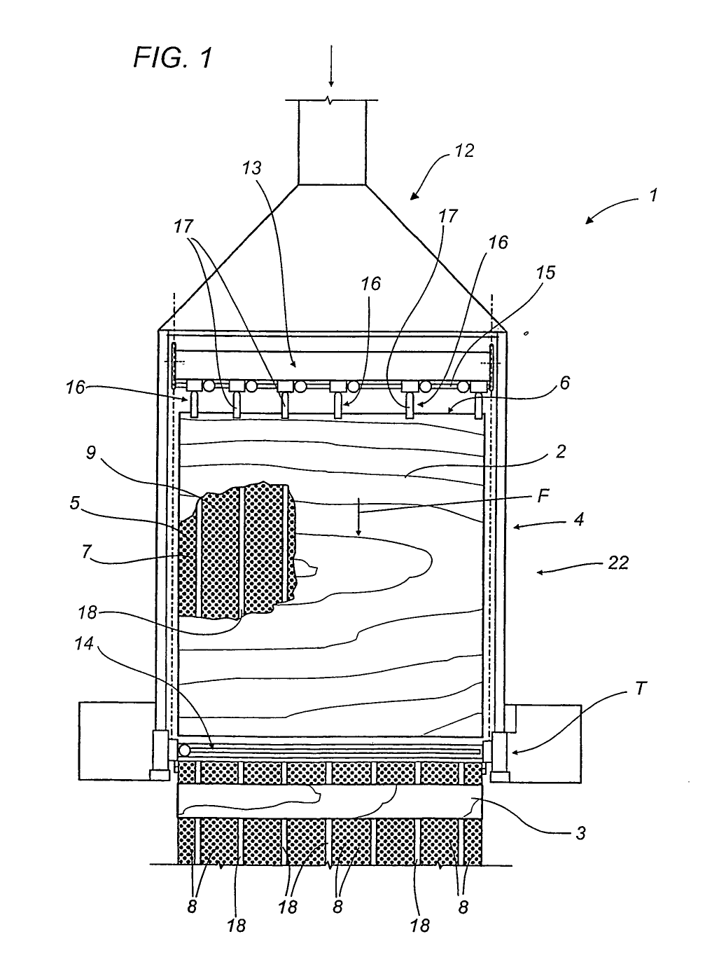

With reference to FIG. 1, the numeral 1 denotes a panel saw machine as a whole for cutting objects or products such as panels 2, or sheets or plates, made of wood-based material.

The machine 1, of the known type as regards its structure and operation, is designed to cut the panels 2 transversally into smaller sub-panels 3.

The machine 1 comprises an air cushion support and sliding device 4, in turn comprising a horizontal support and sliding table 5 for the panels 2, which are stacked vertically one on top of another forming a pack 6 of panels to be cut at a cutting station T.

The table 5 is made in such a way as to allow facilitated panel 2 pack 6 sliding on the table 5 in a given linear feed direction F.

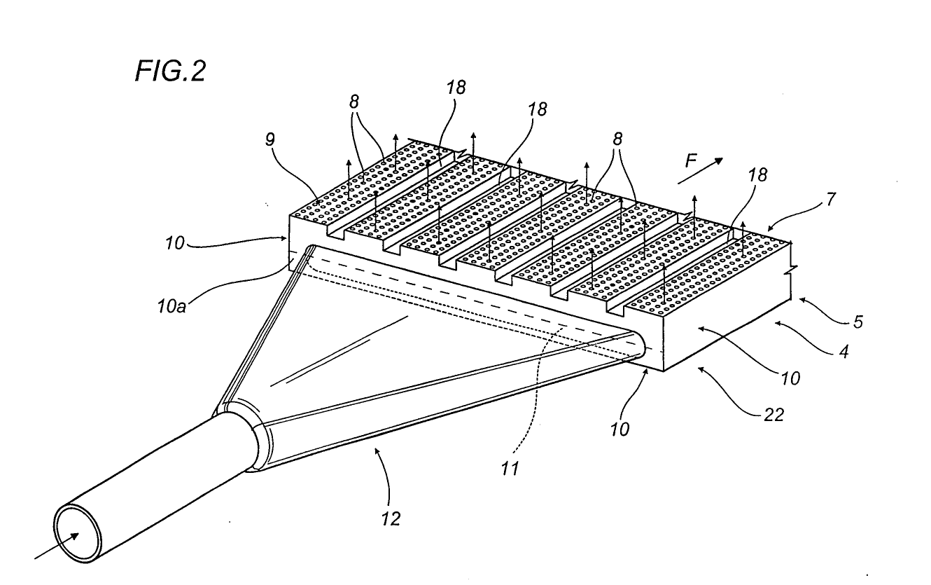

As is more clearly illustrated in FIG. 2, the table 5 consists of a panel 7, having the shape of a rectangular parallelepiped, at least partially consisting of composite wood-based material, and specifically at least partially made of MDF (Medium Density Fibreboard). The MDF is preferably of the water-repellent and/or flame-retardant type.

MDF is a material naturally porous to air and the panel 7 has a plurality of natural pores or micropores 8 designed to allow the air to flow through. The pores 8, enlarged in FIGS. 1 and 2 for graphic requirements, are naturally distributed in a substantially uniform fashion in the panel 7 and in particular are distributed in a substantially uniform and capillary manner on a horizontal support and sliding surface 9 of the panel 7. Alternatively, the panel 7 may be at least partially made of HDF (High Density Fibreboard) or porous aluminium. Like MDF, both HDF and aluminium have a natural and uniform porosity to air.

The outside of the panel 7 is delimited not just by the surface 9, but by five surfaces 10 (one of which is not visible in FIG. 2) which are impermeable to air. The surfaces 10 are made impermeable by a surface treatment, for example painting, on the surfaces 10.

Of these surfaces 10, at least one, labelled 10a, has a portion which is not made impermeable and which forms an inlet 11 for blowing air into the panel 7. The inlet 11 is connected in an airtight fashion to a pipe 12, in which a given quantity of air can be blown by a ventilation device or a compressor of the known type and not illustrated.

Therefore, as described above, the panel 7 forms a pipe or distributor box for the air blown in, made in a single part (or single module) using simple carpentry and painting operations. This also means that it is easy to produce the panel 7 not just in the rectangular parallelepiped shape illustrated, but also in more complex and ergonomic shapes and geometries.

The machine 1 also has means for transferring the panels 2 along the table 5, comprising a mobile pusher item of equipment 13 designed, when activated, to push the panels 2 along the table 5 in the direction F towards the cutting station T in which a cutting device 14 is located.

The equipment 13 comprises a crosspiece 15 able to move in the direction of feed F so as to supply the cutting device 14 with periodic feed movements, with preset quantities, packs 6 of panels 2. During the rest periods between one feed movement and another, the cutting device 14 operates in such a way as to cut the packs 6 of panels 2 transversally to the direction of feed F.

The pusher equipment 13 comprises at least one gripper element 16 designed to hold the panels 2 in position during the cutting operation. Each gripper element 16 is operatively connected to a zone of the rear edge of at least one panel 2 and stops this edge from moving while cutting takes place.

The equipment 13 preferably has a plurality of gripper elements 16 (in FIG. 1 there are 6) alongside one another in a horizontal direction normal to direction F. Each gripper element 16 comprises a clamp consisting of an upper clamping part 17, for holding down the rear edge of the panel 2 on the top of the pack 6, and a lower clamping part (not illustrated in FIG. 1) which acts on the rear edge of the lower panel 2 in the pack 6: in this case, the two clamping parts act in conjunction with one another like two jaws to grip the entire pack 6 at its rear edges. The clamping parts of each gripper element 16 are activated by control means which are known and illustrated.

As is more clearly illustrated in FIG. 2, the lower clamping part of each gripper element 16 can slide in the direction F along a groove 18 in the panel 7, which is obtained by longitudinal routing on the panel 7. The groove may be made impermeable to air, in the same way as the surfaces 10.

In an embodiment not illustrated, the inlet 11 is substituted with a plurality of smaller inlets. These inlets may be made in one, several or all of the surfaces 10.

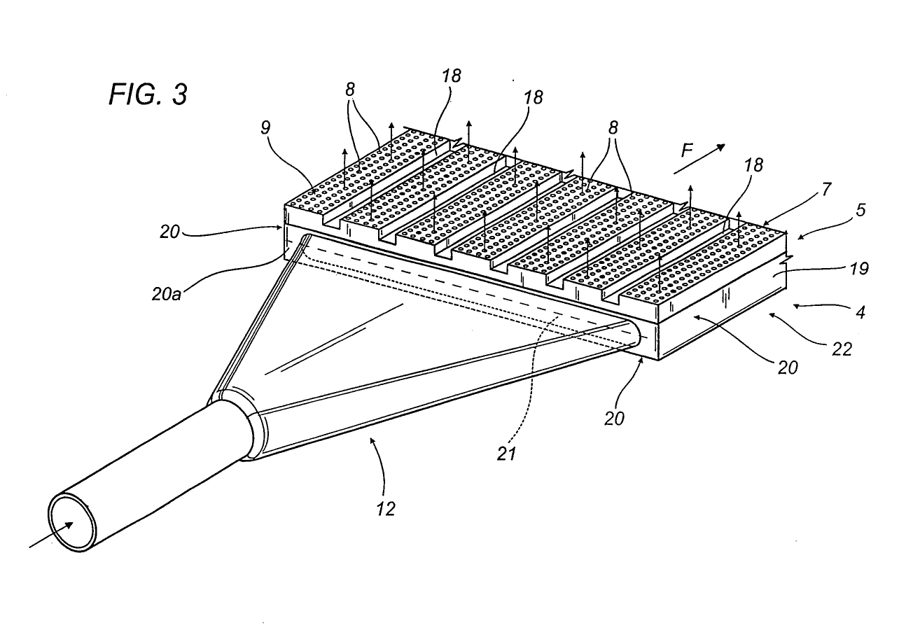

In the embodiment illustrated in FIG. 3, the panel 7 which forms the table 5 is substituted with a panel which is similar but thinner. In this case, the panel, still labelled 7, seals the top of an upper outlet from an air pipe or distribution box 19, which is also part of the device 4.

The box 19 has the shape of a box-like parallelepiped and is made, for example, of metal or plastic.

Similarly to the description referring to FIG. 2, the outside of the box 19 is delimited by five surfaces 20 (one of which is not visible in FIG. 3) impermeable to air. Of these surfaces 20, at least one, labelled 20a, has an inlet 21 for blowing air into the box 19. The inlet 21 is connected in an airtight fashion to the above-mentioned pipe 12, into which a given quantity of air can be blown by a ventilation device or compressor of the known type and not illustrated.

Obviously, the surface of the panel 7 facing the inside of the box 19 is not made impermeable in this case, whilst the sides of the panel 7 may conveniently be made impermeable.

Moreover, again in an embodiment which is not illustrated, the inlet 21 is substituted with a plurality of smaller inlets, which can be made on one, several or all of the surfaces 20.

With reference to both the panel 7 in FIG. 2 and the panel in FIG. 3, the air which flows out of the pores 8 of the surfaces 9 in a capillary fashion generates an upward thrust which opposes the weight of the packs 6 of panels 2. In this way, the resulting force on the support and sliding table 5 is noticeably reduced with a consequent reduction in friction.

The panels 7 in FIGS. 2 and 3 are easy and economical to make and simple to clean. Moreover, they allow the packs 6 of panels to be supported in a substantially uniform way and are at the same time strong. In addition, in contrast to conventional air cushion tables, thanks to the capillary and uniform porous structure, the panels 7 in FIGS. 2 and 3 do not generate troublesome air jets which hit the body of operators working in contact with the panels 7.

In addition, the air is blown into the panels 7 with low pressure values, at approximately atmospheric pressure or lower, and exits each pore 8 with a low displacement and at a low speed and, therefore, with a contained noise level. Thanks to the reduced size of the pores 8, the panels 7 also act as a natural filter for dust or other polluting agents which may be carried towards the machining zone.

Obviously, the device 4 and machine 1 can be subject to numerous modifications and variations without thereby departing from the scope of the inventive concept. For example, the device 4 may have two or more panels 7 positioned in various configurations relative to one another, and the machine 1 may have more than one device 4 positioned relative to one another. The panel 7 may also have a different shape to that illustrated and described above and/or it may not have the grooves 18.

Moreover, it is important to emphasise that the device 4, in all of the embodiments covered by this inventive concept, although particularly advantageous when used on panel saw machines, may also be used in other machines or, simply, in conveyor units for objects or products in general, and with significant advantages in the case of large, heavy objects or products.

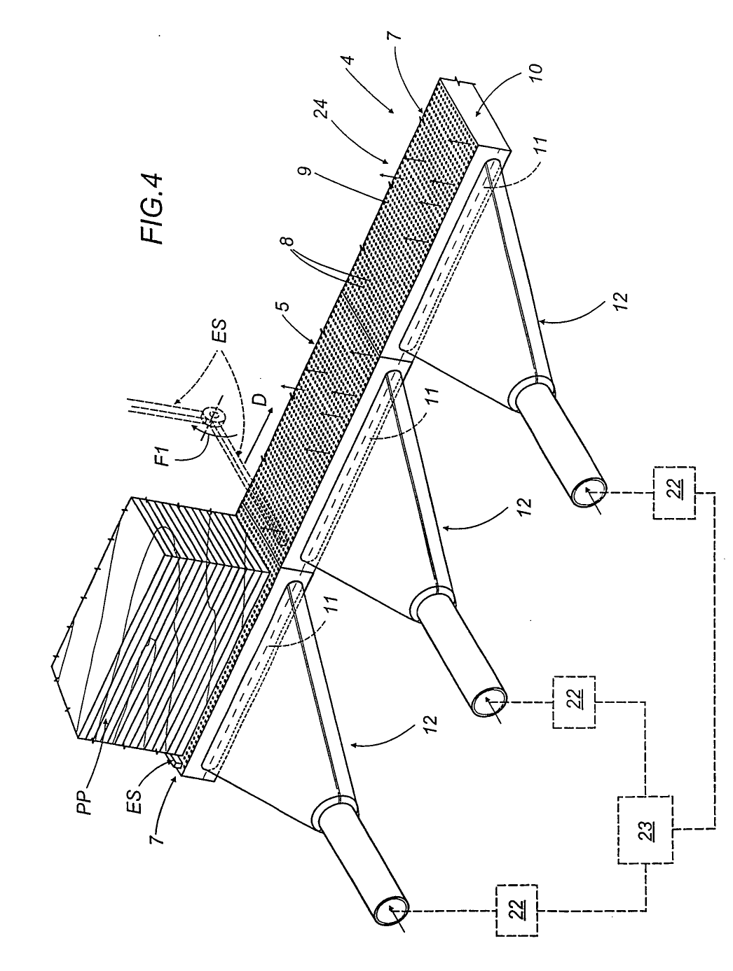

In light of this, in the embodiment illustrated in FIG. 4, the device 4 is part of a conveyor unit 24 for objects or products in general, schematically illustrated as a stack of panels labelled PP, which may be very heavy and have to be transferred along the system line, for example from the panel saw machine outfeed to the magazine for stacking products obtained in this way.

The device 4 comprises a plurality of panels 7, only three of which are illustrated in FIG. 4 to simplify the description. They are set side-by-side in a cascade formation to form a single support and sliding table 5 divided into as many sectors (or modules) as there are panels 7. The table 5 is preferably angled downwards in the desired direction D of object feed so that, when pushed up by the air exiting the pores 8, the objects can slide on the table 5 under the action of gravity.

Each panel 7 is identical to that in FIG. 2, except that it does not have the grooves 18. In particular, each panel 7 is made using the same materials used to make the panel 7 of FIG. 2 and can be made partially impermeable, in the same way as the panel 7 of FIG. 2.

Air is blown in using the same method as described with reference to FIG. 2, including the alternative embodiments, and in particular the inlet 11 of each panel 7 is connected in an airtight fashion to a pipe 12, in which a given quantity of air can be blown by a customary ventilation device or compressor 22.

The controlled movement of the objects in the direction D is guaranteed by a control unit 23 which selectively and successively switches the ventilation devices or compressors 22 connected to the pipes 12 on and off. Obviously, as an object passes between two adjacent panels 7, both panels 7 have air blown into them, and the descent of an object may be slowed by simply switching off the device 22 connected to the panel 7 on which the object lies.

It is also important to emphasise that switching the devices 22 on and off allows, on one hand, significant energy saving, since the energy used to compress the air is reduced, and, on the other hand, a further reduction in the noise produced by the air exiting the panels 7.

As an alternative to the above-mentioned gravity conveying, the stacks of packs PP may be moved by pusher elements (schematically illustrated and labelled ES in FIG. 4). These may consist of bars which are mobile in the direction D and which can turn in the direction F1 in order to retract outside the stack PP dimensions or to form a pusher element as illustrated with a continuous line in FIG. 4. For synchronised movement, the bars may be controlled by the above-mentioned control unit 23.

Finally, it should also be mentioned that the conveyor unit 24 described with reference to FIG. 4 may constitute a conveyor unit for packs of panels in a panel saw machine designed to cut panels, in particular in a machine of the type described with reference to FIGS. 1 to 3.

The solution adopted, therefore, allows significant weights to be supported and can easily be applied to any system which has to move a product along well-defined trajectories and even long conveyor sections. This is all possible together with easy intervention on the sections of the conveyors, to modify their trajectory, reducing the sources of noise and with the advantage of not having negative effects (scratching) on the surface of the product which rests on the conveyor table.

1. An air cushion support and sliding device comprising at least one support and sliding table (5) for objects or products (2); the device being characterised in that the table (5) is made at least partially of a material which is naturally porous to air.

2. The device according to claim 1, characterised in that the table (5) consists of a panel (7) with a plurality of natural pores (8) through which the air flows and is distributed in a substantially uniform and capillary fashion on at least a first support and sliding surface (9) on the table (5).

3. The device according to claim 2, characterised in that the table (5) has at least a second surface (10, 18) which is impermeable to air.

4. The device according to claim 3, characterised in that the table (5) has at least a third surface (10a) forming at least one inlet (11) through which air can be blown into the table (5).

5. The device according to claim 1 or 2, characterised in that it comprises an air pipe or distributor box (19); the pipe (19) having at least one inlet (21) for blowing air into the pipe (19) and an upper air outlet sealed by the support and sliding table (5).

6. The device according to any of the claims from 1 to 5, characterised in that the support and sliding table (5) is made at least partially of a composite wood-based material.

7. The device according to claim 6, characterised in that the support and sliding table (5) is made at least partially of MDF (Medium Density Fibreboard).

8. The device according to claim 7, characterised in that the support and sliding table (5) is made at least partially of water-repellent and/or flame-retardant MDF (Medium Density Fibreboard).

9. The device according to claim 6, characterised in that the support and sliding table (5) is made at least partially of HDF (High Density Fibreboard).

10. The device according to any of the claims from 1 to 5, characterised in that the support and sliding table (5) is made at least partially of porous aluminium.

11. The device according to any of the claims from 1 to 10, characterised in that the support and sliding table (5) forms a natural filter for the air which passes through the table (5).

12. A conveyor unit for conveying objects or products, characterised in that it comprises at least one air cushion support and sliding device (4) in accordance with any of the claims from 1 to 11.

13. A conveyor unit for objects or products, comprising at least one support and sliding device (4) for the objects or products and characterised in that the support and sliding device (4) comprises at least one support and sliding panel (7) for the objects or products, the panel (7) at least partially consisting of a material which is naturally porous to air.

14. The conveyor unit according to claim 13, characterised in that the support and sliding device (4) comprises ventilation or compressor means (22) connected to the panel (7) for blowing air into the panel (7).

15. The conveyor unit according to claim 13, characterised in that the support and sliding device (4) comprises a plurality of panels or modules (7), arranged side-by-side in a cascade formation to form a support and sliding table (5), the latter being divided into as many conveyor sectors as there are panels (7), and a plurality of ventilation or compressor means (22), each connected to a respective panel (7) for blowing air into the panel (7).

16. The conveyor unit according to claim 15, characterised in that the support and sliding device (4) comprises a control unit (23) for the ventilation or compressor means (22) designed to selectively switch the ventilation or compressor means (22) on and off.

17. The conveyor unit according to claim 16, characterised in that the control unit (23) for the ventilation or compressor means (22) is designed to switch the ventilation or compressor means (22) on and off in succession.

18. The conveyor unit according to any of the claims from 13 to 17, characterised in that the panel (7) has a plurality of natural pores (8) through which the air flows and is distributed in a substantially uniform and capillary fashion on at least a first support and sliding surface (9) on the panel (7).

19. The conveyor unit according to claim 18, characterised in that the panel (7) is made at least partially of a composite wood-based material.

20. The conveyor unit according to claim 19, characterised in that the panel (7) is made at least partially of MDF (Medium Density Fibreboard).

21. The conveyor unit according to claim 20, characterised in that the panel (7) is made at least partially of water-repellent and/or flame-retardant MDF (Medium Density Fibreboard).

22. The conveyor unit according to claim 19, characterised in that the panel (7) is made at least partially of HDF (High Density Fibreboard).

23. The conveyor unit according to claim 18, characterised in that the panel (7) is made at least partially of porous aluminium.

24. The conveyor unit according to any of the claims from 13 to 23, characterised in that the panel (7) forms a natural filter for the air which passes through the panel (7).

25. A panel saw machine for cutting panels, characterised in that it comprises at least one air cushion support and sliding device (4) in accordance with any of the claims from 1 to 11.

26. A panel saw machine for cutting panels, characterised in that it comprises at least one conveyor unit (24) in accordance with any of the claims from 12 to 24.
